(19) United States
(12) Patent Application Publication
(10) Pub. No.: US 2014/0351008 A1
(43) Pub. Date: Nov. 27, 2014

(54) CALCULATING MACHINE, PREDICTION METHOD, AND PREDICTION PROGRAM

(71) Applicant: Hitachi, Ltd., Tokyo (JP)

(72) Inventors: MASAYUKI OYAMATSU, Tokyo (JP); Kazushige HIROI, Tokyo (JP)

(73) Assignee: Hitachi, Ltd., Tokyo (JP)

(21) Appl. No.: 14/281,266

(22) Filed: May 19, 2014

(30) Foreign Application Priority Data
May 27, 2013 (JP) 2013-110868

(51) Int. Cl. G06Q 30/02; G06Q 50/00

(52) U.S. Cl. CPC G06Q 30/0202; G06Q 50/01
USPC 705/7.29

(57) ABSTRACT

A calculating machine stores intermediate data generated for each product based on social media data including statements on a plurality of products. The intermediate data about each of the products includes at least a frequency of statements on each of the products for a predetermined period of time. The products include a first product that is not displayed for provision to a consumer at a present time, or at least a second product that has been displayed for provision at the present time. The calculating machine stores sales amount data indicating a sales amount of the second product, and calculates a social media correlation degree indicating a correlation between the intermediate data about the first product and the intermediate data about the second product to predict a sales amount of the first product based on the calculated social media correlation degree and the sales amount data about the second product.

### CROSS-REFERENCE TO RELATED APPLICATIONS

This application claims the priority of Japanese Patent Application No. 2013-110868, filed on May 27, 2013, which is incorporated herein by reference in its entirety.

### BACKGROUND OF THE INVENTION

1. Field of the Invention

The present invention relates to a calculating machine.

2. Description of the Related Art

Retailers analyze point of sales (POS) data in order to increase the efficiency of the stock control of the product that the company deals in and to have various products. The POS data is analyzed using various indexes, for example, of sales amount and profit for each product or each store, and the POS data is used as the criterion for the confirmation of the performance in the budget or for the management judgment in future. Meanwhile, the retailers predict the demand based on the sales performance in the past obtained from the POS data analysis to optimize the amount of stock based on the predicted demand.

When using the POS data analysis, the retailers can predict only the demand for the product that they have sold in the past. However, there is not POS data about a new product or a product that has been released, is currently not dealt in and cannot be provided to consumers, for example, due to the stock shortage. Thus, the retailers cannot analyze the POS data about the new product or the product that the retailers do not deal in. Accordingly, it is actually impossible to predict the demand for the new product or the product that the retailers do not deal in from the POS data.

In light of the foregoing, the retailers often predict the demand for such a new product or product that the retailers do not deal in by intuition based on the cases of the similar product that the retailers have dealt in in the past.

A technique of quantitatively predicting the demand for a product that has not been dealt in has been proposed in the past (see JP-2003-187051-A). JP-2003-187051-A describes “a business plan support device including a purchase probability calculation unit configured to calculate the purchase probability at present based on the purchase probability in the past according to the rate of the product price to the earnings of the purchaser in the past and the rate of the product price to the earnings of the potential purchaser at present, and a sale prediction unit configured to calculate the prediction number of the sold products based on the calculated purchase probability”.

### SUMMARY OF THE INVENTION

JP-2003-187051-A describes the process for calculating the purchase probability based on the product price and the earning of the purchaser in the past in order to calculate the prediction number of sales based on the calculated purchase probability. However, the purchaser that has purchased the product in the past does not necessarily purchase a product as estimated. Thus, the demand for the product sometimes does not correspond to the prediction number of sales. Such a fact that the demand for the product sometimes does not correspond to the prediction number of sales is caused because the purchaser's reputation and feeling about the product are not considered in the process described in JP-2003-187051-A.

For example, when consumers have a bad impression of a product after the public announcement of the release of the product, the number of sales can be lower than the prediction number of sales without analyzing the reputation and the feeling. On the other hand, when consumers have a good impression of a product after the public announcement of the release of the product, the number of sales can be higher than the predicted number of sales without analyzing the reputation and the feeling and this can cause the shortage in production and the stock shortage.

An object of the present invention is to provide a method for appropriately predicting the sales amount of a new product or a product that has not been dealt in in consideration of the purchaser's reputation or feeling about the product.

According to a representative embodiment of the present invention, a calculating machine includes: a processor; and a memory, wherein the calculating machine stores intermediate data generated for each of a plurality of products or services based on social media data including statements on the products or services for a predetermined period of time in the memory, the intermediate data includes at least a frequency of statements on each of the products or services for the predetermined period of time, the products or services include a first product or service that is not displayed for provision to a consumer at a present time, and at least a second product or service that has been displayed for provision at the present time, and the calculating machine stores sales amount data indicating a sales amount of the second product or service in the memory, and includes a correlation degree calculation unit configured to calculate a social media correlation degree indicating a correlation between the intermediate data about the first product or service and the intermediate data about the second product or service, and a demand prediction unit configured to predict a sales amount of the first product or service based on the calculated social media correlation degree and the sales amount data about the second product or service.

According to an embodiment of the invention, the sales amount of a product that has not been sold can appropriately be predicted based on the reputation prior to the release or the sales performance of the related product.

The problems, configurations, and effects other than the above will be clarified in the description of the embodiment to be described below.

### BRIEF DESCRIPTION OF THE DRAWINGS

FIG. 1 is a block diagram of an exemplary configuration of a demand prediction device according to the present embodiment;

FIG. 2 is an explanatory diagram of the process and data of a demand prediction program executed in a CPU according to the present embodiment;

FIG. 3 is a flowchart of the process in a social media data analysis unit according to the present embodiment;

FIG. 4 is an explanatory diagram of exemplary social media intermediate data according to the present embodiment;

FIG. 5 is a flowchart of the process in a product correlation degree calculation unit according to the present embodiment;

FIG. 6 is a flowchart of the process for calculating the social media correlation degree between the products according to the present embodiment;

FIG. 7 is an explanatory diagram of exemplary product information according to the present embodiment;

FIG. 8 is a flowchart of the process for calculating the product correlation degree according to the present embodiment;

FIG. 9 is a flowchart of the process in an external factor contribution degree calculation unit according to the present embodiment;

FIG. 10 is an explanatory diagram of exemplary sales amount data according to the present embodiment;

FIG. 11 is an explanatory diagram of exemplary external event data according to the present embodiment;

FIG. 12 is an explanatory diagram of exemplary demand prediction data according to the present embodiment;

FIG. 13 is an explanatory diagram of exemplary external factor data according to the present embodiment; and

FIG. 14 is an explanatory diagram of an exemplary product demand prediction screen output with a visualization unit according to the present embodiment.

### DESCRIPTION OF THE PREFERRED EMBODIMENTS

The embodiment will hereinafter be described in detail with reference to the appended drawings.

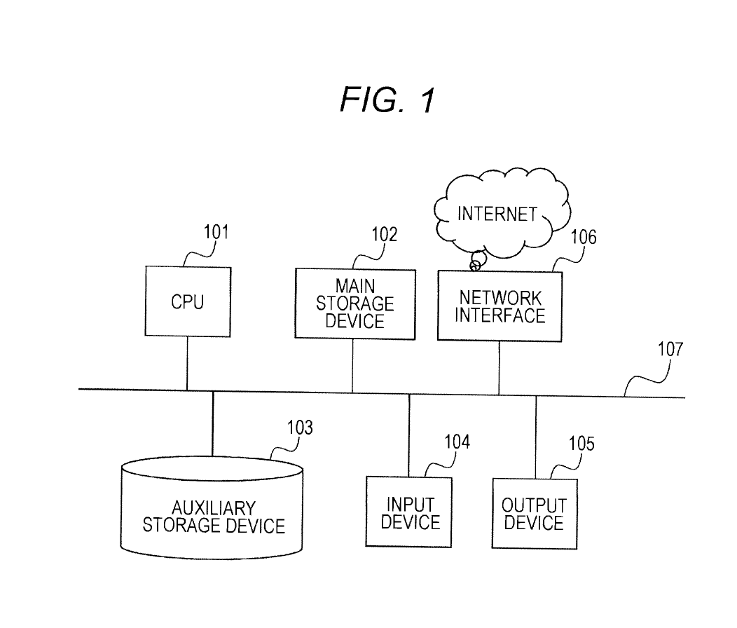

FIG. 1 is a block diagram of an exemplary configuration of a demand prediction device according to the present embodiment.

The demand prediction device includes a plurality of devices such as a CPU 101, a main storage device 102, an auxiliary storage device 103, an input device 104, an output device 105, and a network interface 106. The devices are connected to each other through a bus 107 to input and output data through the bus 107.

The CPU 101 performs various processes such as input of data, calculation, output of data in the demand prediction program according to the demand prediction program included in the main storage device 102. The CPU 101 can be any processor that is an arithmetic device for executing a program. The demand prediction program according to the present embodiment includes a plurality of functions.

The main storage device 102 is a memory in which the demand prediction program and data to be executed with the CPU 101 are developed. The main storage device 102 is, for example, a non-volatile memory such as a RAM.

The auxiliary storage device 103 stores the data and demand prediction program included in the demand prediction device. The auxiliary storage device 103 inputs data to the main storage device 102 and receives the data output from the main storage device 102 according to the instruction from the CPU 101. The auxiliary storage device 103 is formed of, for example, a magnetic disk such as a hard disk drive (HDD) or an optical disk such as a DVD. The auxiliary storage device 103 can be formed of a plurality of storage devices.

The input device 104 is configured to receive the instruction from the user using the demand prediction device and transmit the received instruction to the CPU 101. The input device 104 is, for example, a keyboard, a mouse, or a touch panel.

The output device 105 is configured to provide the result from the process in the demand prediction device to the user based on the instruction from the CPU 101. The output device 105 is configured to display the user interface. The output device 105 is, for example, a printer, or a liquid crystal display. When a liquid crystal display or the like works as the output device 105, the output device 105 displays the user interface.

The network interface 106 is configured to receive, for example, the social media data through the Internet. The contents of the data that network interface 106 receives is controlled with the function that the CPU 101 performs. The network interface 106 includes, for example, a network interface card (NIC) or a wireless LAN interface card.

The demand prediction device according to the present embodiment can be installed a retail store that provides a product or service to a consumer directly or can be a sever connected to the terminal provided in each of a plurality of retail stores through a network.

Note that, when the retail store deals in service as a subject to be sold, the demand prediction device according to the present embodiment also predicts the demand for the service. The demand prediction device to be described below predicts the demand for a product. However, the demand prediction device can also predict the demand for the service in the same manner.

An exemplary demand prediction program in the demand prediction device will be described hereinafter.

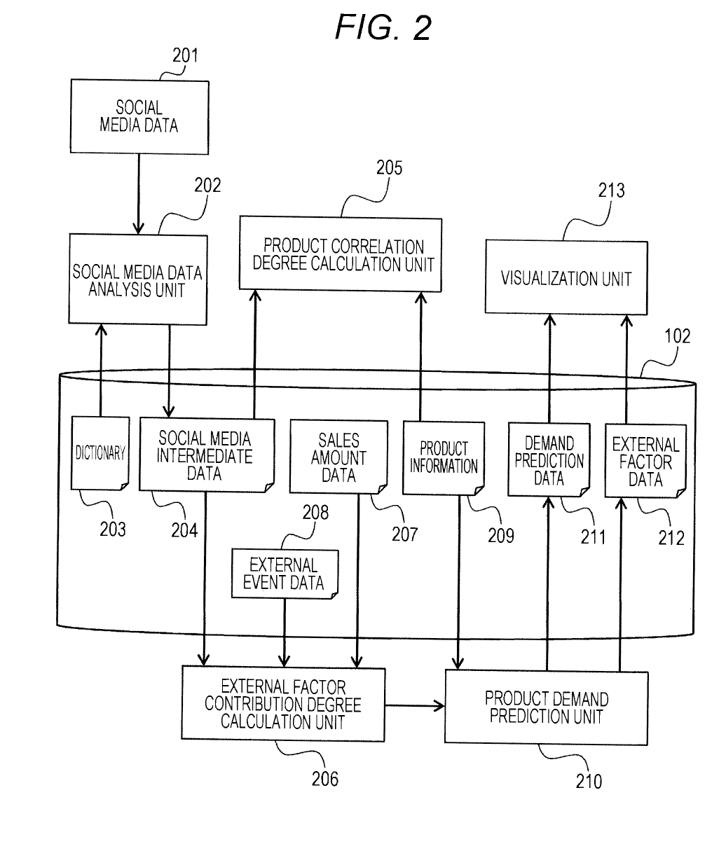

FIG. 2 is an explanatory diagram of the process of a demand prediction program and data executed in the CPU 101 according to the present embodiment.

The demand prediction program according to the present embodiment includes a social media data analysis unit 202, a product correlation degree calculation unit 205, an external factor contribution degree calculation unit 206, a product demand prediction unit 210, and a visualization unit 213. Each function of the demand prediction device illustrated in FIG. 2 is implemented with the demand prediction program that the CPU 101 executes.

However, each function of the demand prediction device according to the present embodiment can also be implemented, for example, with a physical processing unit such as an integrated circuit. Furthermore, each function of the demand prediction device can also be implemented with a plurality of programs or a program.

A dictionary 203, social media intermediate data 204, sales amount data 207, external event data 208, product information 209, demand prediction data 211, and external factor data 212 are stored in the main storage device 102, and can also be stored in the auxiliary storage device 103 as necessary, for example, depending on the amount of data.

<Social Media Data Analysis>

The social media data 201 is generated in the social media service such as a blog or the social network service (SNS). The format for the social media data 201 is determined depending on the operated service. The social media data 201 indicates information in various formats, for example, structured data such as HTML or XML, or data that does not has a structure especially, such as JavaScript Object Notation (JSON) (JavaScript is a registered trademark).

The social media data analysis unit 202 collects the social media data 201 from a plurality of servers connected to the Internet through the network interface 106 illustrated in FIG. 1. Then, the social media data analysis unit 202 analyzes the collected social media data 201 to store the analysis result as the social media intermediate data 204 in the main storage device 102 in the demand prediction device according to the present embodiment.

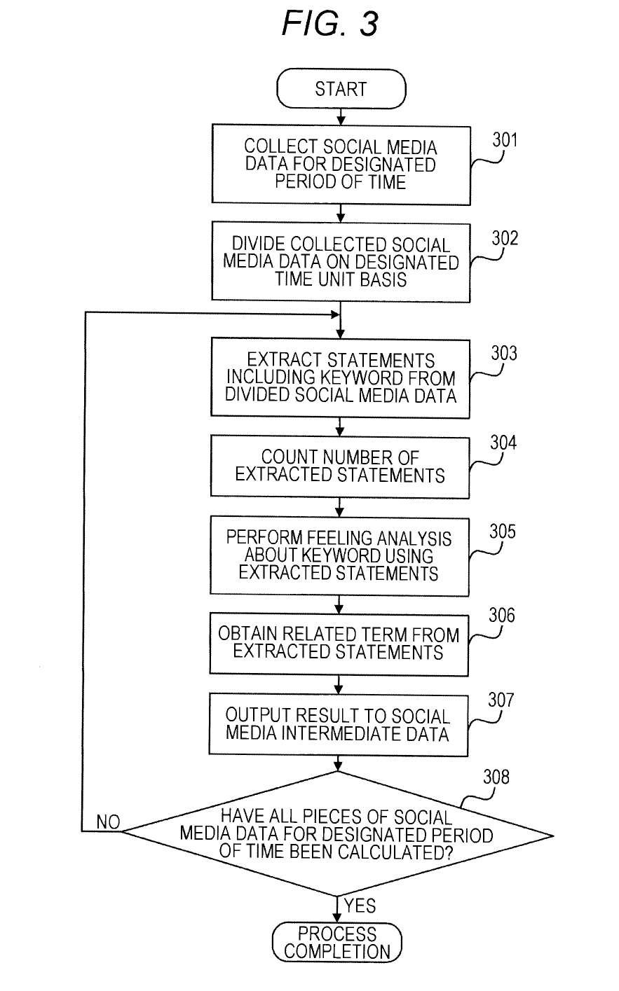

FIG. 3 is a flowchart of the process in the social media data analysis unit 202 according to the present embodiment.

The social media data analysis unit 202 starts the process illustrated in FIG. 3 according to the instruction from the CPU 101. The social media data analysis unit 202 collects the social media data 201 for a designated period of time in the above-mentioned method (step 301).

In that case, for example, a past period before the start of the process illustrated in FIG. 3 can be designated as the designated period of time, or a period of time from the start to the present time can be designated. When the process illustrated in FIG. 3 is performed for the keyword (product) about which the social media intermediate data 204 has been generated, the period of time from the last time when the social media has been collected to the present time can be designated as the designated period of time. The predetermined designated period of time can be set in advance in the main storage device 102, or can be input by the user through the input device 104.

The CPU 101 gives the instruction to the social media data analysis unit 202 to start the process illustrated in FIG. 3 periodically or at the time of the user instruction. When the user wants to predict the demand for a product that has not been released, the user can give an instruction to the CPU 101 to activate the social media data analysis unit 202. Furthermore, when the user wants to collect the reputation or the like about a released product, the user can give an instruction to the CPU 101 to activate the social media data analysis unit 202.

The social media data analysis unit 202 collects the social media data 201 in step 301 using a obtaining unit that the service such a blog or the SNS opens to public (for example, an API). The collected social media data 201 has a large amount of data. Thus, in step 301, the social media data analysis unit 202 can collect only the social media data 201 including a word included in the dictionary 203 in advance. Alternatively, the social media data analysis unit 202 eliminates the social media data 201 including a word included in the dictionary 203 from the social media data 201 to be collected.

After step 301, the social media data analysis unit 202 divides the collected social media data 201 on a predetermined time unit basis (step 302). In that case, the predetermined time unit means a unit to analyze the social media data analysis unit 202 and is, for example, a unit by year, month, week, or hour. In that case, the predetermined time unit can be set in advance, or can be input by the user through the input device 104.

In the process to be described below, the predetermined time unit is by the day. However, the predetermined time unit can be a unit other than by the day.

The social media data analysis unit 202 analyzes the time information included in the social media data 201 collected in step 301 and divides the social media data 201 on a predetermined time unit basis.

In and after step 302, each function processes each of the pieces of the divided social media data 201. Hereinafter, the divided social media data 201 will merely be referred to as the pieces of social media data.

After step 302, the social media data analysis unit 202 extracts statements including a predetermined keyword from each piece of the social media data (step 303). In that case, at least an identifier (product name) such as the name of the product for which the demand is to be predicted is included in the predetermined keyword.

The predetermined keyword can be set in the main storage device 102 in advance, or can be designated by the user through the input device 104. The identifier indicating the product included in the predetermined keyword is not necessarily the exact name of the product, and can be a part of the name of the product. For example, the predetermined keyword can be a “prawn fried rice” in the name of the product “special prawn fried rice”. Alternatively, a plurality of keywords, such as a “special prawn fried rice” and a “prawn fried rice”, can be designated as the predetermined keyword.

The social media data analysis unit 202 analyzes the text included in each piece of the social media data to extract the statements including the predetermined keyword from the text in step 303.

After step 303, the social media data analysis unit 202 calculates the number of statements extracted in step 303 (step 304).

After step 304, the social media data analysis unit 202 performs a feeling analysis about the predetermined keyword using each of the statements extracted in step 303 to calculate the number of statements of each feeling (step 305).

Specifically, in step 305, the social media data analysis unit 202 classifies the contents of the extracted statements into affirmative, negative, and neutral opinions on the product indicated by the predetermined keyword by performing the feeling analysis for the statements extracted in step 303. The method for classifying the contents of the statements is, for example, a method in which the social media data analysis unit 202 classifies the statement including an affirmative word as an affirmative opinion using the words indicating affirmative or negative and stored in the dictionary 203.

Alternatively, the method can be a method in which the social media data analysis unit 202 classifies the statement as an affirmative opinion or a negative opinion by directly comparing the word stored in the dictionary 203 to the statement. Alternatively, the method can be a method in which the social media data analysis unit 202 determines whether the statement includes an affirmative or negative expression while combining the affirmative or negative words stored in the dictionary 203.

When classifying the contents of the statements while combining the words, the social media data analysis unit 202 can analyze the statement in a morphological analysis.

The social media data analysis unit 202 further calculates each of the numbers of the statements that includes an affirmative opinion, that includes a negative opinion, and that does not include either of an affirmative opinion and a negative opinion in step 305.

After step 305, the social media data analysis unit 202 obtains a term related to the product name indicated by the predetermined keyword from the statement extracted in step 303 (step 306). Specifically, the social media data analysis unit 202 divides the text of the statement extracted in step 303 into words using a method, for example, the morphological analysis. The social media data analysis unit 202 obtains all the words divided from each statement as the terms related to the statement. The social media data analysis unit 202 calculates the frequency in generation of each of the obtained related terms at each piece of the social media data.

To reduce the number of the related terms to be stored in the social media intermediate data 204, the social media data analysis unit 202 can extract the related terms of which frequency is higher than a predetermined frequency from among the related terms in step 306.

Alternatively, the social media data analysis unit 202 can calculate the term frequency-inverse document frequency (TF-IDF) of the related term instead of the frequency in step 306 to store the calculated TF-IDF in the social media intermediate data 204. The TF-IDF is a value indicating the weight of a word in a sentence, and is calculated based on two indexes, of the term frequency and inverse document frequency.

After step 306, the social media data analysis unit 202 stores the result from the processes in steps 303 to 306 in the social media intermediate data 204 (step 307).

After step 307, the social media data analysis unit 202 determines whether the processes in steps 303 to 307 have been performed for all the pieces of the social media data 201 collected in step 301 (step 308). When the collected social media data 201 includes the data that has not been processed, for example, in step 303, the social media data analysis unit 202 goes back to step 303.

When all pieces of the collected social media data 201 have been processed, for example, in step 303, the social media data analysis unit 202 terminates the process illustrated in FIG. 3.

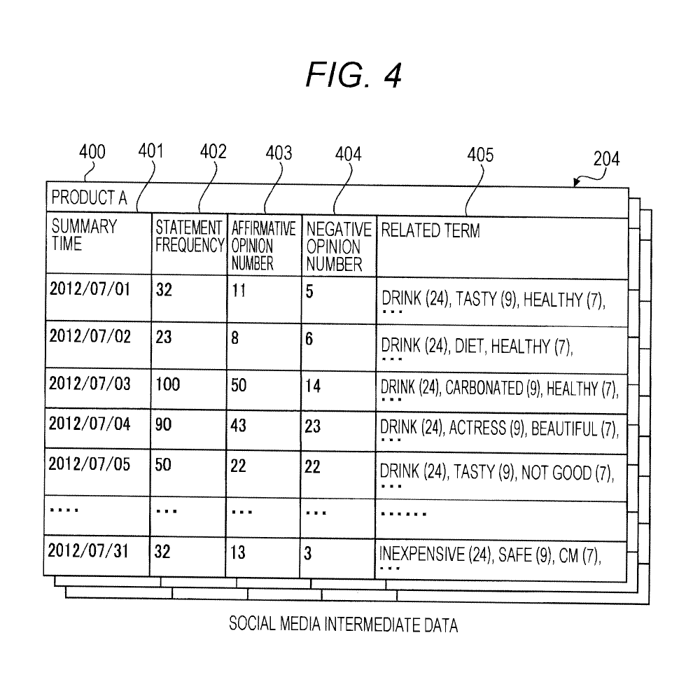

FIG. 4 is an explanatory diagram of exemplary social media intermediate data 204 according to the present embodiment.

A plurality of pieces of the social media intermediate data included in the social media intermediate data 204 is generated for each product. The social media intermediate data 204 includes a product name 400, a summary time 401, a statement frequency 402, an affirmative opinion number 403, a negative opinion number 404, and a related term 405.

The product name 400 indicates an identifier that uniquely indicates a product and, for example, indicates the name of the product. The user can input an identifier as the product name 400 in step 307. Alternatively, an appropriate keyword can be stored as the product name 400 when the keyword has been used in step 303 and is the identifier that uniquely indicates the product.

The summary time 401 indicates the period of time divided on the predetermined time unit basis in step 302. When the predetermined time unit in step 302 is by the day, the summary time 401 indicates a date and each entry in the social media intermediate data 204 includes the information about the statements on the product indicated in the product name 400 per day.

The statement frequency 402 is the number of the statements on the product indicated in the product name 400. The number has been calculated in step 304. The number of the statements is stored in the statement frequency 402 in step 307.

The affirmative opinion number 403 is the number of the statements of affirmative opinions on the product indicated in the product name 400. The number has been calculated in step 305. The number of the statements is stored in the affirmative opinion number 403 in step 307.

The negative opinion number 404 is the number of the statements of negative opinions on the product indicated in the product name 400. The number has been calculated in step 305. The number of the statements is stored in the negative opinion number 404 in step 307.

The related term 405 is the related term to the product indicated in the product name 400 and the frequency of the term. The term has been obtained in step 306. The related term and the frequency are stored in the related term 405 in step 307.

The social media data analysis unit 202 stores the term obtained in step 306 and the term frequency in the social media intermediate data 204 while linking them to each other in step 307. When a plurality of related terms exist, the social media data analysis unit 202 can distinguish the related terms from each other using a delimiting character such as “,” as illustrated in the related term 405 of FIG. 4.

When performing the process illustrated in FIG. 3 using the product name of the product for which the social media intermediate data 204 has been generated as the keyword, the social media data analysis unit 202 adds a new entry to the social media intermediate data 204 of the product stored in the main storage device 102 in step 307. Then, the social media data analysis unit 202 stores the result from the processes in steps 303 to 306 that have been performed again in the new entry. Accordingly, the social media data analysis unit 202 can generate the social media intermediate data 204 using the latest social media data 201.

The social media data analysis unit 202 performs the process illustrated in FIG. 3. This stores the social media intermediate data 204 about the product of which demand is to be predicted in the main storage device 102. The social media data analysis unit 202 performs the process illustrated in FIG. 3 repeatedly for a plurality of products. This generates the social media intermediate data 204 about the released products.

Note that the social media data analysis unit 202 can receive the social media intermediate data 204 from a device different from the demand prediction device according to the present embodiment to store the data in the main storage device 102.

<Method for Calculating Correlation Degree Between Products>

The product correlation degree calculation unit 205 calculates the social media correlation degree that indicates the correlations between the statement frequency 402, the affirmative opinion number 403, and the negative opinion number 404 of the product of which demand is to be predicted (hereinafter, referred to as a designated product) in the social media, and the statement frequency 402, the affirmative opinion number 403, and the negative opinion number 404 of the related product that has been sold in the past. The product correlation degree calculation unit 205 changes the period of time in which the correlation degree is predicted depending on whether the product of which demand is to be predicted has not been released or has been released.

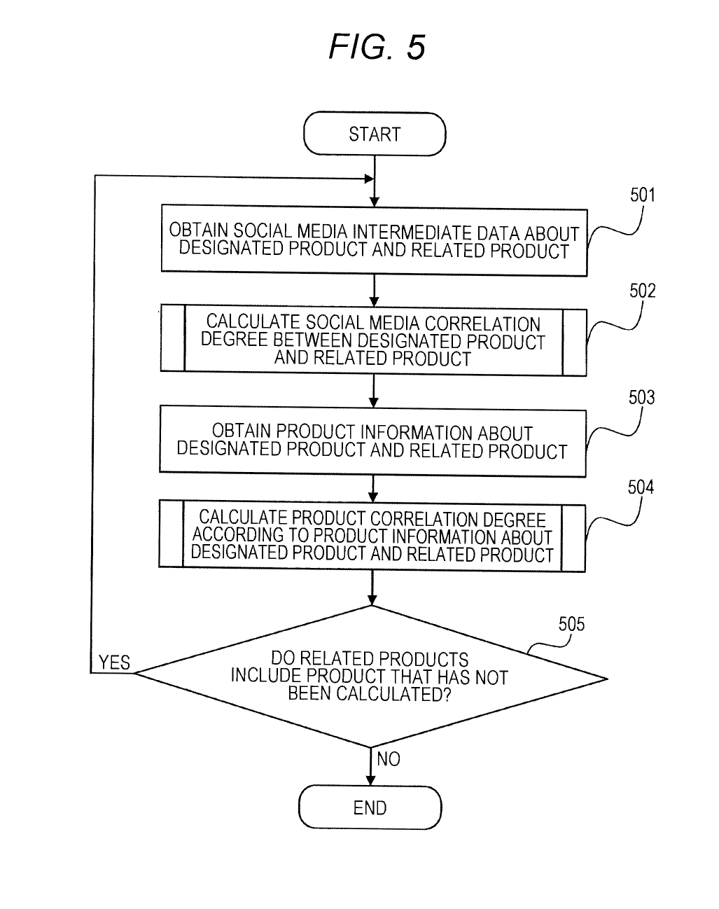

FIG. 5 is a flowchart of the process in the product correlation degree calculation unit 205 according to the present embodiment.

The product correlation degree calculation unit 205 starts the process illustrated in FIG. 5 according to the instruction from the CPU 101. Note that the user inputs the identifier of the designated product and the identifier of at least one of the related products to the designated product into the product correlation degree calculation unit 205 through the input device 104 at the start of the process illustrated in FIG. 5.

The designated product is a subject of which sales amount is to be predicted. The related product has been dealt in at the start of the process illustrated in FIG. 5.

In that case, when receiving the identifier of the designated product from the user, the product correlation degree calculation unit 205 can extract, as the related product, the product that has been classified as the same product as the designated product and that has been dealt in with reference to the product information 209 to be described below.

The product correlation degree calculation unit 205 performs the processes in steps 501 to 504 for each of the identifiers of the related products. Thus, the processes in steps 501 to 504 will be described hereinafter on the assumption that a related product exists.

The product correlation degree calculation unit 205 obtains the social media intermediate data 204 about the designated product and the related product (step 501). When the social media intermediate data 204 about the designated product or the related product does not exist, the product correlation degree calculation unit 205 can give an instruction through the CPU 101 to the social media data analysis unit 202 to generate new social media intermediate data 204 about the designated product or the related product.

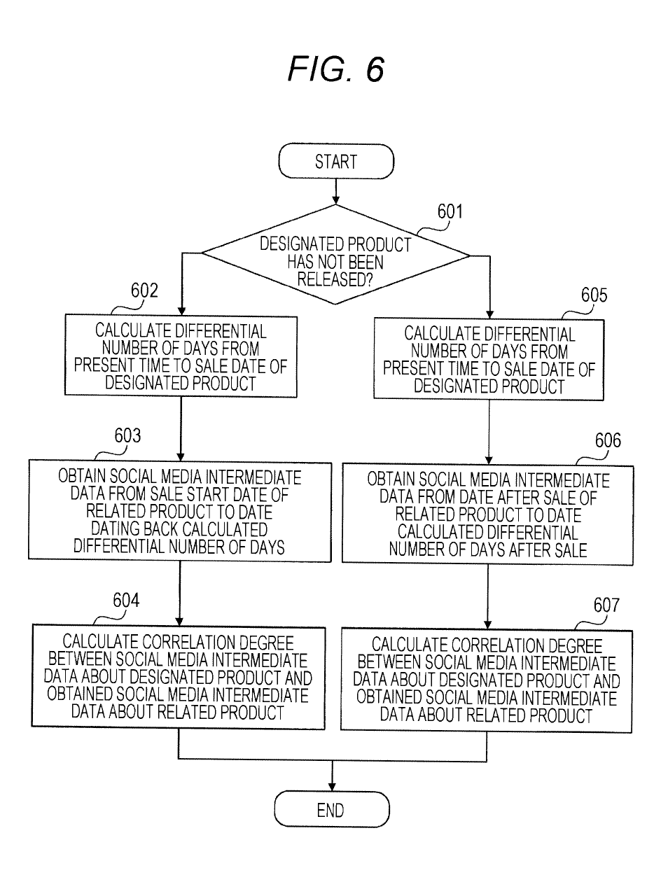

The product correlation degree calculation unit 205 calculates the social media correlation degree indicating the correlation between the designated product and the related product based on the social media intermediate data 204 obtained in step 501 (step 502). FIG. 6 illustrates the detailed flow in step 502.

FIG. 6 is a flowchart of the process for calculating the social media correlation degree between the products according to the present embodiment.

The product correlation degree calculation unit 205 determines whether the designated product has not been released or has been released (including the sale date in the present embodiment) at the present time (step 601) in order to calculate the social media correlation degree based on the social media intermediate data 204 in step 502. The demand prediction device according to the present embodiment can obtain the present time from the timer that the demand prediction device includes, or through the Internet or the like.

The product correlation degree calculation unit 205 determines using the product information 209 to be described below whether the designated product has not been released at the present time. The product information 209 according to the present embodiment indicates whether a product has not been released or has been released at the present time, and whether each retail store deals in the product when the product has been released.

Note that, in the present embodiment, the fact that the manufacturer of the product starts putting the product on the distribution channel is referred to as release. Furthermore, the fact that a retail store provides the product to the consumers and displays the product for provision is referred to as dealing in. In the present embodiment, each retail store sometimes does not deal in the product even after the release of the product due to the stock shortage or the commercial policy.

When the designated product has not been unreleased at the present time, the process goes to step 602. When the designated product has been released and is not dealt in at the present time, the process goes to step 605. Note that, when the designated product has been released and is dealt in at the present time, the demand prediction device can predict the demand using a conventional demand prediction method.

When the designated product has not been released at the present time, the product correlation degree calculation unit 205 calculates the differential number of days from the present time to the sale date of the designated product based on the product information 209 (step 602). The product information 209 indicates the information about the sale date of the product. The product correlation degree calculation unit 205 can find the sale date of the product based on only the product information 209, or the product information 209 and the present time.

Note that, as described above, the product correlation degree calculation unit 205 calculates the differential number of days between the sale date of the designated product and the present time. However, when the product information 209 indicates the sale date and time of the product, the product correlation degree calculation unit 205 can calculate the time difference between the present time and the sale date and time. When the product information 209 indicates the sale month of the product, the product correlation degree calculation unit 205 can calculate the differential number of months between the present time and the sale month.

The product correlation degree calculation unit 205 specifies the temporal relationship between the sale date of the designated product and the present time by determining whether the designated product has not been released in step 601, and calculates the time difference between the present time and the sale date in step 602 (or step 605). The product correlation degree calculation unit 205 calculates a reference time of the related product in step 603 (or step 606) using the temporal relationship and the time difference (the relationship between the sale date and the present time).

After step 602, the product correlation degree calculation unit 205 calculates the date (reference time) dating back the differential number of days calculated in step 602 from the sale date of the related product to the past because the present time is the date before the sale date in the specified temporal relationship. In that case, the calculated reference time of the related product corresponds to the present time of the designated product. The product correlation degree calculation unit 205 further calculates the number of entries (the number of entries about the designated product) stored in the social media intermediate data 204 about the designated product.

Then, the product correlation degree calculation unit 205 extracts the past social media intermediate data 204 until the calculated reference time of the related product from the social media intermediate data 204 of the related product by the number of entries of the designated product (step 603). Specifically, the product correlation degree calculation unit 205 extracts the entries in the social media intermediate data 204 in which the summary time 401 indicates the past time before the reference time from the social media intermediate data 204 in which the product name 400 indicates the related product by the period of time that is the same as the social media intermediate data 204 about the designated product.

The process in step 603 and the process in step 606 to be described below enable the product correlation degree calculation unit 205 to appropriately extract the social media intermediate data 204 about the related product to be compared with the social media intermediate data 204 about the designated product.

After step 603, the product correlation degree calculation unit 205 calculates the correlation degree between the entry about the designated product in the social media intermediate data 204 and the entry about the related product in the social media intermediate data 204 obtained in step 603 (hereinafter, referred to as a social media correlation degree) (step 604). The process in step 604 is based on the assumption that the sales amount of the designated product can vary similarly to the sales amount of the related product when the reputation about the designated product before release in the social media is compared to the reputation about the related product that has been sold in the past before release in the social media and the reputations are similar to each other.

An exemplary calculation of the social media correlation degree in step 604 will be described hereinafter. The product correlation degree calculation unit 205 finds the cross-correlation function, for example, using the distance at each time between the function indicating the transition of a plurality of statement frequencies 402 of the designated product and the function indicating the transition of a plurality of statement frequencies 402 of the related product. The higher value the cross-correlation function according to the present embodiment outputs, the larger the distance between the functions is, in other words, the more different the social media intermediate data 204 about the designated product is from the social media intermediate data 204 about the related product.

The product correlation degree calculation unit 205 can find the cross-correlation function of the functions indicating the transition of the affirmative opinion number 403 or the functions indicating the transition of the negative opinion number 404. The product correlation degree calculation unit 205 can find the cross-correlation function of the functions indicating the transition of the rate of the affirmative opinion number 403 to the statement frequency 402 or the functions indicating the transition of the rate of the negative opinion number 404 to the statement frequency 402.

Instead of the cross-correlation function of the transition of the rate, the product correlation degree calculation unit 205 can find each of the rates of the affirmative opinion number 403 and the negative opinion number 404 to the statement frequency 402 (referred to as the negative opinion rate and the affirmative opinion rate, respectively) for all the entries in the social media intermediate data 204 about the designated product.

The product correlation degree calculation unit 205 can find the negative opinion rate and the affirmative opinion rate based on the entries about the related product extracted in step 603. The product correlation degree calculation unit 205 can arbitrarily weight the ratio between the negative opinion rate and affirmative opinion rate of the designated product, and arbitrarily weight the ratio between the negative opinion rate and affirmative opinion rate of the related product and then find the sum. The product correlation degree calculation unit 205 can obtain the sum as the social media correlation degree.

The product correlation degree calculation unit 205 can use the related term 405 to calculate the social media correlation degree. For example, the product correlation degree calculation unit 205 finds the number of the same related words included in each of the entry about the designated product and the extracted entry about the related product to obtain the number as the correlation degree. The product correlation degree calculation unit 205 can find the cross-correlation function indicating the time-series transition of a specific related term so as to calculate the social media correlation degree from the found cross-correlation function.

Furthermore, the product correlation degree calculation unit 205 can use at least one of the above-mentioned methods for calculating the social media correlation degree, or can calculate the social media correlation degree using a plurality of the methods to arbitrarily weight the calculated social media correlation degrees in order to calculate the sum of the weighted calculated social media correlation degrees. Then, the product correlation degree calculation unit 205 can output the calculated sum of the social media correlation degrees as the result of the social media correlation degree in step 604.

The aforementioned social media correlation degree is calculated using the social media intermediate data 204 about the designated product until the present time and the social media intermediate data 204 about the related product until the reference time. However, the product correlation degree calculation unit 205 can change the reference time within a predetermined range so as to extract a plurality of sets of the pieces of the social media intermediate data 204 about the related product. Then, the product correlation degree calculation unit 205 can find the correlation degrees of each of the extracted sets and the social media intermediate data 204 about the designated product until the present time to output the maximum value among the found correlation degrees as the social media correlation degree.

The product correlation degree calculation unit 205 calculates the social media correlation degree in step 604 as described above, and the process in step 502 illustrated in FIG. 5 is completed.

Next, the processes from step 605 when the designated product has been released and the designated product is not dealt in at the present time will be described.

When it is determined in step 601 that the designated product has been released and the designated product is not dealt in at the present time, the product correlation degree calculation unit 205 finds the differential number of days from the present time to the sale date of the designated product based on the product information 209, similarly to in step 602 (step 605).

After step 605, the product correlation degree calculation unit 205 calculates the date by adding the differential number of days found in step 602 to the sale date of the related product (the reference time) because the specified temporal relationship indicates that the designated product has been released at the present time. In that case, the calculated reference time of the related product corresponds to the present time of the designated product. The product correlation degree calculation unit 205 calculates the number of entries (the number of the entries of the designated product) stored in the social media intermediate data 204 about the designated product.

Then, the product correlation degree calculation unit 205 extracts the past social media intermediate data 204 until the calculated date of the related product from the social media intermediate data 204 of the related product by the number of entries of the designated product (step 606).

After step 606, the product correlation degree calculation unit 205 calculates the social media correlation degree between the social media intermediate data 204 about the designated product and the social media intermediate data 204 about the related product extracted in step 606 (step 607). The method for calculating the social media correlation degree in step 607 is the same as in step 604.

The process in step 607 is based on the assumption that the sales amount of the designated product can vary similarly to the sales amount of the related product when the reputation about the designated product before and after release in the social media is compared to the reputation about the related product that has been sold in the past before and after release in the social media and the reputations are similar to each other.

The product correlation degree calculation unit 205 calculates the social media correlation degree in step 607 as described above, and the process in step 502 illustrated in FIG. 5 is completed. After the completion of the process illustrated in FIG. 6, the product correlation degree calculation unit 205 performs the process in step 503 illustrated in FIG. 5.

The product correlation degree calculation unit 205 obtains the attribute of the designated product and each of the related products, such as the classifications or prices of the products, from the product information 209 in FIG. 2 (step 503) after calculating the social media correlation degree using the social media intermediate data 204 in step 502.

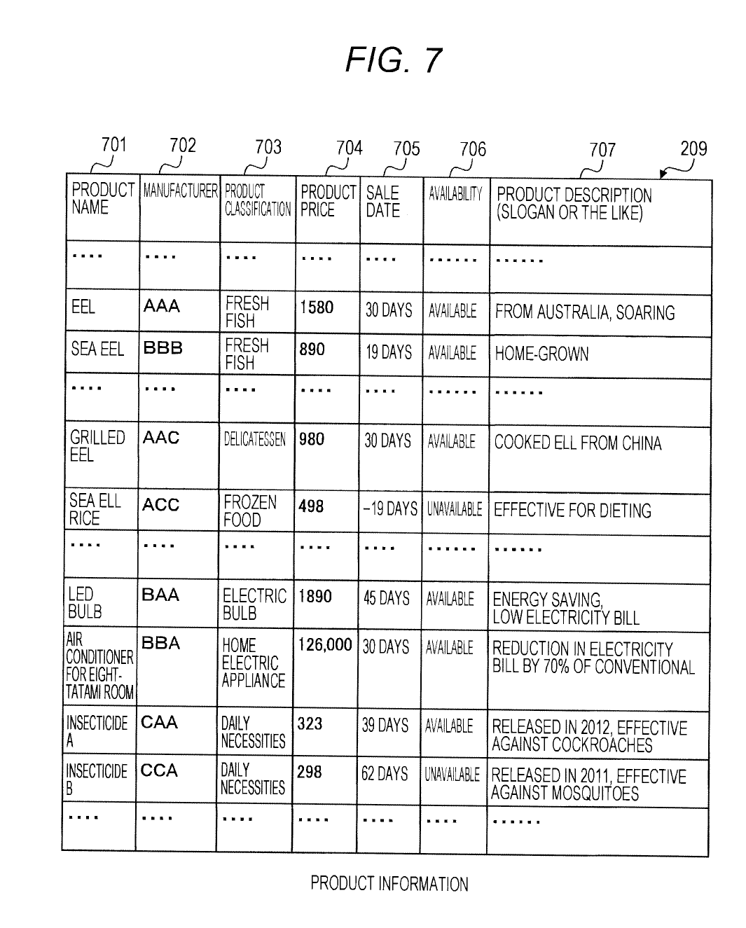

FIG. 7 is an explanatory diagram of exemplary product information 209 according to the present embodiment.

The product information 209 includes the information about the product that the user of the demand prediction device according to the present embodiment provides to the consumers or that the user is to provide to the consumers in the future (the attribute of the product). The products indicated in the product information 209 include the designated product and the related product.

The product information 209 includes items such as a product name 701, a manufacturer 702, a product classification 703, a product price 704, a sale date 705, and availability 706, and a product description 707. The user sets the product name 701, the manufacturer 702, the product classification 703, the product price 704, and the product description 707 in the product information 209 before the release of the product. At least the manufacturer 702, the product classification 703, the product price 704, and the product description 707 correspond to the attribute of the product according to the present embodiment.

The product name 701 includes an identifier that uniquely indicates the product. The product name 701 according to the present embodiment indicates the product name. The product name 701 corresponds to the identifier of each of the designated product and the related product.

The manufacturer 702 includes an identifier that indicates the manufacturer of the product that the product name 701 indicates. The product classification 703 indicates the classification of the product. The product classification 703 indicates the classification name such as “fresh fish” or “drink”. The product price 704 indicates the sales price of the product that the product name 701 indicates.

The sale date indicates the sale date of the product that the product name 701 indicates. The sale date 705 illustrated in FIG. 7 indicates the relative number of the days from the sale date to the present time. Thus, the sale date 705 of a product that has not been released indicates a minus value.

Note that the sale date 705 can indicate the year, month, and day that indicate the absolute date. When the sale date 705 indicates the absolute date, the user sets the value as the sale date 705 in advance. When the sale date 705 indicates the relative number of the days, the sale date 705 is updated with the CPU 101 periodically (for example, by the day).

The availability 706 indicates whether the product that the product name 701 indicates is dealt in. The user updates the availability 706 as necessary.

When the demand prediction device is installed at each retail store and the retail store at which the demand prediction device is installed deals in the product, the availability 706 indicates that the product is available. When the demand prediction device is a server and connected to the terminal of each retail store and at least one of the retail stores deals in the product, the availability 706 can indicate that the product is available.

The product description 707 describes the product that the product name 701 indicates. Terms or sentences that characterize the product, such as the origin or “mellow”, are stored in the product description 707.

Note that the product information 209 according to the present embodiment includes at least the product name 701, the sale date 705, and the availability 706, and additionally includes another piece of information as necessary. For example, the product information 209 can include the attribute indicating a large classification (for example, “drink”), and a middle classification (for example, “soft drinks” or “carbonated drinks”) in the product classification 703.

The main storage device 102 or the auxiliary storage device 103 can store a list of the manufacturers or the product classifications corresponding to the manufacturer 702 and the product classification 703. The manufacturer 702 and the product classification 703 can include an identifier represented by number instead of the name of the manufacturer and the name of the product classification. When the identifier of the manufacturer 702 or the product classification 703 is represented by number, each function of the demand prediction device obtains the information about the manufacturer or the product classification by linking the number to the name included in the list of manufacturer or the product classification.

In step 503, the product correlation degree calculation unit 205 obtains the attribute of the entry in the product information 209 in which the product name 701 indicates the designated product and the attribute of the entry in the product information 209 in which the product name 701 indicates the related product.

After step 503, the product correlation degree calculation unit 205 calculates the product correlation degree based on the attribute of the designated product and the attribute of the related product (step 504).

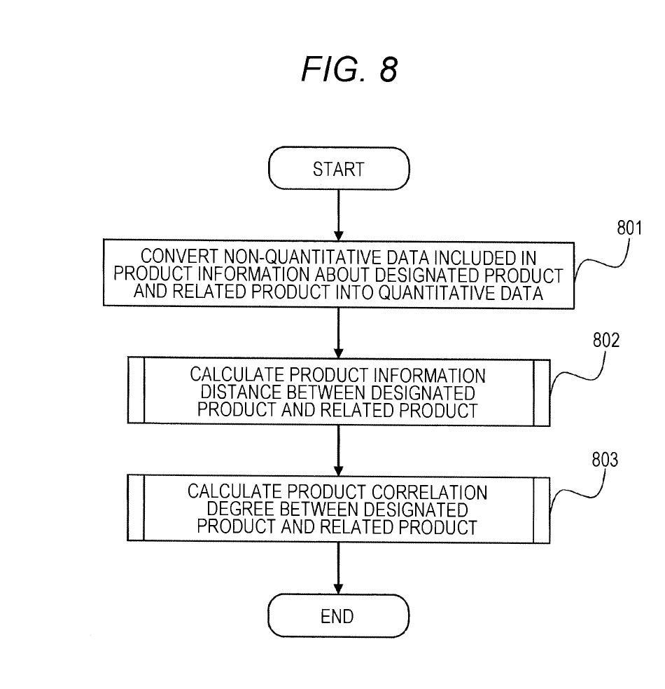

FIG. 8 is a flowchart of the process for calculating the product correlation degree according to the present embodiment.

The process illustrated in FIG. 8 corresponds to the process in step 504.

The product correlation degree calculation unit 205 converts the non-quantitative data included in the obtained attribute of the designated product and the obtained attribute of the related product into the quantitative data (step 801).

Specifically, when the product information 209 is the product information 209 illustrated in FIG. 7, the product correlation degree calculation unit 205 converts the non-quantitative data, for example, in the manufacturer 702 and the product classification 703 among the items included in the product information 209 into appropriate quantitative data in step 801. The product correlation degree calculation unit 205 converts the pieces of quantitative data that do not have significant difference between the pieces of data among the items included in the product information 209 into appropriate quantitative data, for example, by multiplying the quantitative data by a predetermined value.

For example, the product correlation degree calculation unit 205 converts the “drink” into zero and converts the “fresh fish” into one in the product classification 703. When the main storage device 102 stores a management table in which quantitative numbers are allocated to the identifiers of the product classification 703 and the manufacturer 702, the product correlation degree calculation unit 205 converts the non-quantitative data into the quantitative data using the management table.

The product correlation degree calculation unit 205 does not have to necessarily convert different pieces of the non-quantitative data into different pieces of the quantitative data in step 801. For example, when the product classification 703 of the designated product is the “drink”, the product correlation degree calculation unit 205 can convert the “drink” into one, and convert all the identifiers other than the “drink” in the product classification 703 into zero.

When the product information 209 includes sentences such as the product description 707 illustrated in FIG. 7, the product correlation degree calculation unit 205 can convert the product description 707 into the quantitative data by dividing the sentence in the product description 707 into words using the morphological analysis and calculating the number of the same words included in the product description 707 of the designated product and the product description 707 of the related product.

After step 801, the product correlation degree calculation unit 205 calculates the product information distance between the designated product and the related product (step 802). The product information distance indicates the difference between the attribute of the designated product and the attribute of the related product. The larger the difference is, the more different the attribute of the designated product is from the attribute of the related product.

In step 802, the product correlation degree calculation unit 205 calculates the distance between the product information 209 about the designated product and the product information 209 about the related product, for example, using a method using the Euclidean distance. The product correlation degree calculation unit 205 calculates the distance between the product information 209, for example, using an expression 1.

$$\begin{matrix}[ Mathematical Formula 1 ] & \\ Rp ( n ) = {\sum }_{k}^{ } {{A}_{k} ( \frac{{Z}_{k} - {X}_{k} ( n )}{{Z}_{k}} )}^{2} & ( Expression 1 )\end{matrix}$$

Rp (n): the distance between the product information 209 about the related product and the product information 209 about the designated product
n: the argument indicating the related product
Aₖ: the weight of the kth item included in the product information 209
k: the argument indicating the item included in the product information 209
Zₖ: the quantitative data of the kth item included in the product information 209 about the designated product
Xₖ(n): the quantitative data of the kth item included in the product information 209 about a related product n

The product correlation degree calculation unit 205 outputs a distance Rp(n) calculated in step 802 as the product information distance.

After step 802, the product correlation degree calculation unit 205 calculates the product correlation degree between the designated product and the related product (step 803). In step 803, the product correlation degree calculation unit 205 calculates the product correlation degree using the social media correlation degree calculated in step 502 illustrated in FIG. 5 and the product information distance calculated in the expression 1. Specifically, the product correlation degree calculation unit 205 calculates the product correlation degree using the following expression 2.

[Mathematical Formula 2]

R(n,t)=αₚ·Rp(n)+αₛ·Rs(n,t) (Expression 2)

R(n, t): the product correlation degree of the related product n to the designated product at a time t
Rp(n): the product information distance between the related product n and the designated product
Rs(n, t): the social media correlation degree of the related product n to the designated product at the time t
αₚ, αₛ: the weight of the product information distance and the weight of the social media correlation degree

The more different the attribute of the designated product is from the attribute of the related product, the higher value the product correlation degree (R(n, t)) calculated from the expression 2 has. The more different the social media intermediate data of the designated product is from the social media intermediate data of the related product, the higher value the product correlation degree (R(n, t)) calculated from the expression 2 has. The product correlation degree calculation unit 205 outputs the R (n, t) calculated in step 803 as the product correlation degree of the related product.

After step 803, the product correlation degree calculation unit 205 terminates the process in step 504 illustrated in FIG. 5. The product correlation degree calculation unit 205 determines whether there is a related product of which product correlation degree has not been calculated (step 505). When it is determined in step 505 that there is a related product of which product correlation degree has not been calculated, the product correlation degree calculation unit 205 returns to step 501 to perform the processes in step 501 to step 504 for the next related product. When it is determined that the product correlation degrees of all the related products have been calculated, the product correlation degree calculation unit 205 terminates the process illustrated in FIG. 5.

Calculating the product correlation degree using the attribute of the designated product and the attribute of the related product in the process illustrated in FIG. 8 can calculate the product correlation degree for predicting the sales amount using the similarity between the designated product and the related product. As a result, the product demand prediction unit 210 to be described below can predict the sales amount of the designated product while more strongly reflecting the sales amount data 207 of the related product similar to the designated product. This can improve the accuracy of the prediction of the sales amount.

Note that the product correlation degree calculation unit 205 can extract a specific classification of product as the related product used for predicting the demand by classifying the product using the value of each item in the product information 209. The product correlation degree calculation unit 205 calculates the product correlation degree based on the product information distance and the social media correlation degree. However, the product correlation degree calculation unit 205 according to the present embodiment can output only the social media correlation degree as the product correlation degree by setting αₚ at zero.

<External Factor Contribution Degree Calculation Method>

When the product correlation degree calculation unit 205 has terminated the process illustrated in FIG. 5, the external factor contribution degree calculation unit 206 calculates the effect of an external factor such as the statement frequency in the social media, the competitiveness, the advertisement, or the weather on the sales amount of the product sold in the past as a quantitative index using the social media intermediate data 204, the sales amount data 207, and the external event data 208.

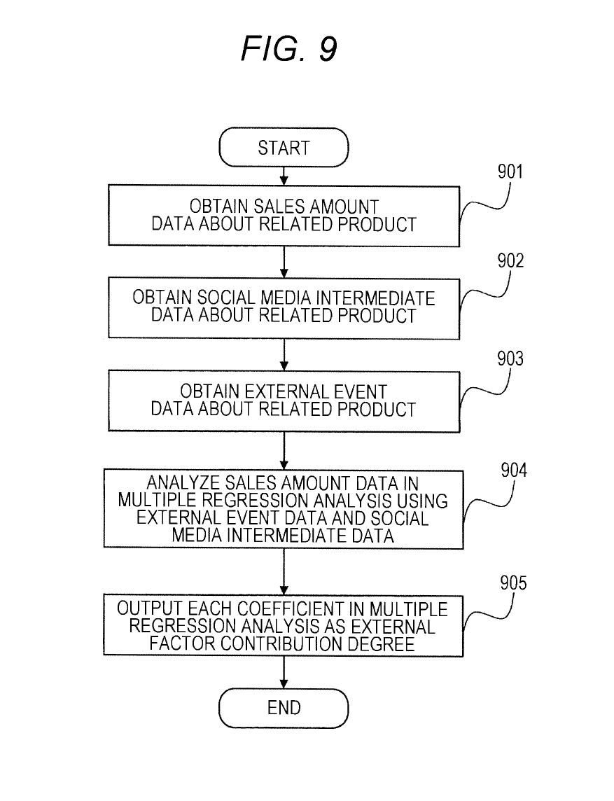

FIG. 9 is a flowchart of the process in the external factor contribution degree calculation unit 206 according to the present embodiment.

The process illustrated in FIG. 9 is performed for each related product.

The external factor contribution degree calculation unit 206 obtains the entry of the related product in the sales amount data 207 (step 901).

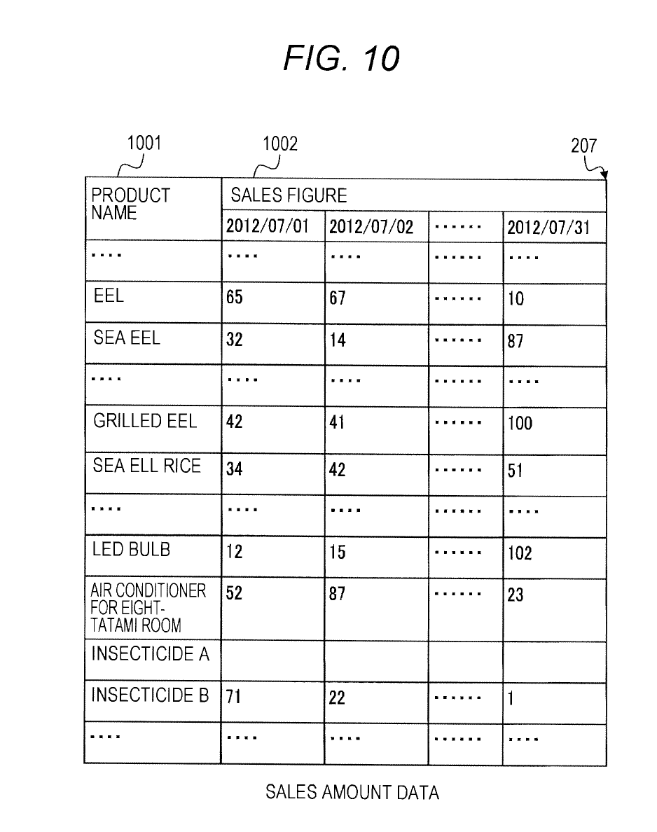

FIG. 10 is an explanatory diagram of the exemplary sales amount data 207 according to the present embodiment.

The sales amount data 207 indicates the sales amount of the product sold in the past. The user updates the sales amount data 207 periodically (for example, by the day). The sales amount data 207 includes the product name 1001 and the sales FIG. 1002.

The product name 1001 indicates the product and corresponds to the product name 701 in the product information 209. The sales FIG. 1002 indicates the sales figure of the product that the product name 701 indicates at each of a plurality of periods of time.

The sales FIG. 1002 includes, for example, the sales figure by the day or by the month as illustrated in FIG. 10. Furthermore, the sales amount data 207 includes the sales figure by the day or by the month in the sales FIG. 1002, and can also include the sales figure, for example, by the period of time in the sales FIG. 1002.

Note that the sales amount data 207 necessarily includes the information to be linked to the entries in the product information 209 (the product name 1001 in the sales amount data 207 illustrated in FIG. 10). However, it is not necessarily only the product name that links the entry in the sales amount data 207 to the entry in the product information 209. For example, a unique ID is given to each entry in the product information 209 illustrated in FIG. 9 such that each entry in the sales amount data 207 can include an appropriate ID.

After step 901, the external factor contribution degree calculation unit 206 obtains the social media intermediate data 204 of the related product (step 902). In step 902, the external factor contribution degree calculation unit 206 determines whether the entry about the related product is included in the social media intermediate data 204. When the entry about the related product is not included, the social media data analysis unit 202 can generate the entry about the related product.

After step 902, the external factor contribution degree calculation unit 206 obtains the external event data 208 about the related product (step 903).

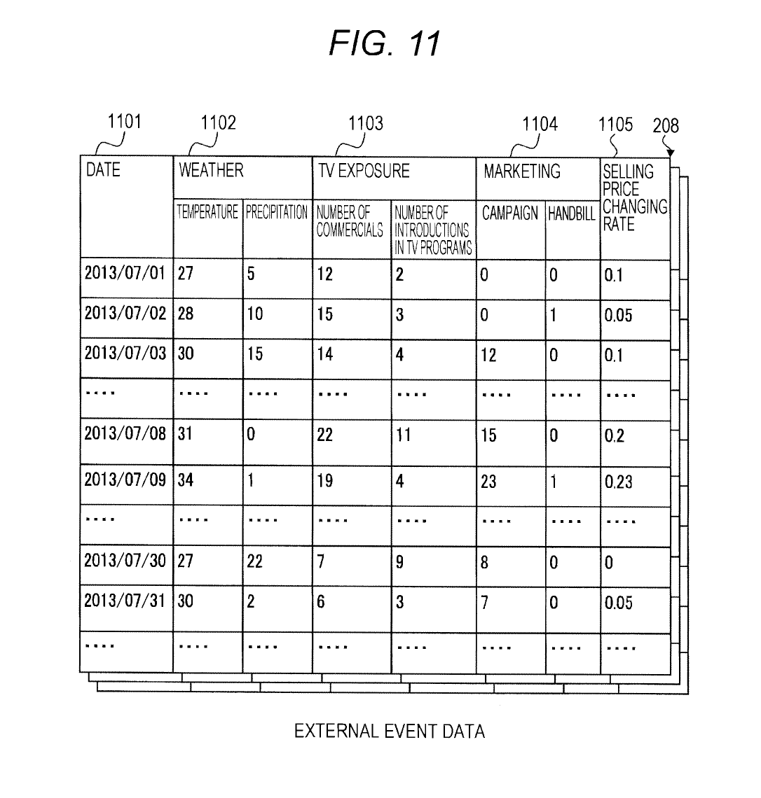

FIG. 11 is an explanatory diagram of exemplary external event data 208 according to the present embodiment.

The external event data 208 indicates the quantitative data about the condition that can give an effect on the sales amount of the product. The external event data 208 includes a date 1101 and, for example, includes the weather data 1102, the TV exposure data 1103, the marketing data 1104, and the selling price changing rate 1105.

The external event data 208 includes each item illustrated in FIG. 11 of each product that the product name 701 in FIG. 7 indicates.

The date 1101 indicates a date. Although indicating the condition by the day, each of the entries in the external event data 208 illustrated in FIG. 11 can indicate the condition, for example, by the week, or by the hour. Note that each of the entries in the external event data 208 corresponds to each of the sales amounts included in the sales FIG. 1002 in the sales amount data 207. Accordingly, when each entry in the external event data 208 indicates the condition by the day, the sales FIG. 1002 includes the value indicating the sales amount by the day.

The weather data 1102 indicates the weather condition on the day indicated in the date 1101. The sales amount of product, for example, clothes or seasonal food can vary depending on the weather condition including the temperature. Thus, the external event data 208 can include the weather condition.

The weather data 1102 includes, for example, the temperature and the amount of precipitation illustrated in FIG. 11. The weather data 1102 can include, for example, the humidity or the amount of snowfall.

The TV exposure data 1103 includes, for example, the number of times that the product has been introduced in commercials or in TV programs on the day indicated in the date 1101. The transmission of the information about the product through the mass media including TV to general consumers can increase or reduce the sales amount of the product. Thus, the external event data 208 can include the number of times that the product has been introduced in commercials or in TV programs. Specifically, the TV exposure data 1103 can include the number of commercials and the number of times that the product has been introduced in TV programs as illustrated in FIG. 11.

The marketing data 1104 indicates the number of special advertisements including advertising campaigns for the product or the number of advertisements in advertisement handbills distributed together with newspapers or the like on the day indicated in the date 1101. The marketing data 1104 is the information about the advertisements that the user of the demand prediction device according to the present embodiment that is the business owner or the organization using the demand prediction device has actively performed.

The advertisements include, for example, touts for the store on the street and the distribution of promotional samples. The marketing data 1104 includes the quantitative data indicating the information about the advertisements. For example, the marketing data 1104 indicates the number of campaigns and the presence or absence of the handbills as illustrated in FIG. 11. When the handbills have been distributed, the marketing data 1104 indicates one in FIG. 11. When the handbills have not been distributed, the marketing data 1104 indicates zero in FIG. 11.

Note that the marketing data 1104 can indicate the amount of money or the number of people necessary to perform the campaigns in addition to the number of campaigns or the like. When the campaign is performed in the implementation period including a plurality of days, the marketing data 1104 in the date 1101 about the implementation period can include the result obtained by dividing the amount of money or the number of people necessary to perform the campaign by the number of the days of the implementation period.

The selling price changing rate 1105 indicates the variation of the selling price of a product. The variation of the selling price of the product can effect on the sales amount of the product. Thus, the external event data 208 can include the selling price changing rate 1105.

The selling price changing rate 1105 can be found, for example, by dividing the selling price of a product by the average value of the selling prices of the product during all the periods in the sale date. Note that, when the selling price changing rate 1105 is included as the item in the external event data 208, the user can calculate the data corresponding to the selling price changing rate 1105 from the sales amount data 207 so as to input the calculated selling price changing rate 1105 into the external event data 208.

The external event data 208 can be generated in a format illustrated in FIG. 11 based on the meteorological data accumulated in a storage device different from the demand prediction device or the information extracted, for example, from the information about a TV program. In addition to the data illustrated in FIG. 11, the external event data 208 can include any type of information when the information indicates the condition in the date 1101 and the condition can effect on the sales amount data.

After step 903, the external factor contribution degree calculation unit 206 analyzes each piece of the sales amount data 207 about the related product in a multiple regression analysis using the external event data 208 and the social media intermediate data 204 (step 904). In step 904, the external factor contribution degree calculation unit 206 calculates the effects of each piece of data in the external event data 208 and the reputation information in the social media on the sales amount data 207 using the multiple regression analysis. For example, the external factor contribution degree calculation unit 206 estimates the sales amount data 207 from an expression 3 to find each coefficient using the multiple regression analysis.

[Mathematical Formula 3]

Y(t)=(t)+a₁x₁(t)+aₘxₘ(t)+ . . . B·Y(t−T)+C (Expression 3)

Y(t): the sales amount data about the related product on a date t
aₘ: the regression coefficient of the explanatory variable
xₘ(t) calculated in the multiple regression analysis
xₘ(t): the quantitative data of the item in the external event data 208 and the social media intermediate data 204 on the date t
m: the argument indicating each item in the external event data 208 and the social media intermediate data 204
B: the coefficient estimated in a demand prediction model for predicting the sales amount on the date t from the sales amount data before a predetermined cycle T from the date t
C: the constant term (including the constant terms in the multiple regression analysis of aₘ and in the demand prediction model of the coefficient B

When calculating each coefficient using the expression 3, the external factor contribution degree calculation unit 206 uses a conventional method such as the multiple regression analysis or the demand prediction model. Note that the external factor contribution degree calculation unit 206 can use only some of the items in the external event data 208 and the social media intermediate data 204 as the explanatory variable in the multiple regression analysis without using all the items.

The external factor contribution degree calculation unit 206 uses one of the statement frequency 402, the affirmative opinion number 403, the negative opinion number 404, and the related term 405 as the item in the social media intermediate data 204 for the multiple regression analysis. When using the related term 405 in the multiple regression analysis, the external factor contribution degree calculation unit 206 can perform the multiple regression analysis while using each of the related terms as the item and using the frequency as the quantitative data.

Alternatively, the external factor contribution degree calculation unit 206 can apply the demand prediction model only to the sales amount data before performing the multiple regression analysis using the expression 3. The external factor contribution degree calculation unit 206 can calculate the regression coefficient by calculating the sales prediction data using the demand prediction model and analyzing the difference between the sales amount data and the sales prediction data in the multiple regression analysis.

Alternatively, the external factor contribution degree calculation unit 206 can divide each of the explanatory variables by the average value of the explanatory variables in order to convert each of the explanatory variables into non-dimensional data in the multiple regression analysis using the expression 3. Furthermore, when the unit is ° C. (Celsius' temperature scale) indicating the temperature illustrated as the weather data 1102 in FIG. 11, the external factor contribution degree calculation unit 206 can appropriately convert the value into a quantitative variable so as to convert the value into the absolute temperature.

After step 904, the external factor contribution degree calculation unit 206 outputs the regression coefficient aₘ, the demand prediction model coefficient B, and the constant term C obtained in the multiple regression analysis in step 904 as the external factor contribution degree (step 905). The external factor contribution degree calculation unit 206 terminates the process illustrated in FIG. 9 after step 905.

The user outputs the output external factor contribution degree on an output screen of the external factor contribution degree to be described below. The user can adjust the external factor contribution degree based on the output result. This enables the product demand prediction unit 210 to be described below to adjust the prediction of the sales amount of the designated product.

<Product Demand Prediction Method>

The product demand prediction unit 210 predicts the sales amount of the product that has not been dealt in using the product correlation degree of the related product calculated with the product correlation degree calculation unit 205, the external factor contribution degree of the related product calculated with the external factor contribution degree calculation unit 206, and the sales amount data 207. Specifically, the product demand prediction unit 210 calculates the sales amount using an expression 4.

$$\begin{matrix}[ Mathematical Formula 4 ] & \\ y ( t ) = \frac{1}{N} {\sum }_{n}^{N} \{ R ( n , {t}_{now} ) \times Y ( n , t - {T}_{n} ) \} & ( Expression 4 )\end{matrix}$$

y(t): the predicted sales amount of the product that has not been dealt in on the date t
R(n, t_{now}): the product correlation degree between the related product n and the designated product at a present time t_{now} (see the expression 2)
Y(n, t−Tₙ): the sales amount data about the related product n and the sales amount data on the day obtained by subtracting the difference Tₙ between the present time t_{now} and the sale date of the related product from the date t (see the expression 3)
N: the total number of the related products

The higher the product correlation degree of each of the related products is, the higher the sales amount calculated using the expression 4 is. The lower the product correlation degree of each of the related products is, the lower the sales amount calculated using the expression 4 is.

The product demand prediction unit 210 predicts the demand for the product (the designated product) that has not been sold until the present time by calculating the prediction sales amount of the designated product on the date t using the expression 4. When the product correlation degree or external factor contribution degree of the related product n has not been calculated, the product demand prediction unit 210 can calculate the product correlation degree or the external factor contribution degree using the product correlation degree calculation unit 205 or the external factor contribution degree calculation unit 206.

The product demand prediction unit 210 can calculate the sales amount y(t) only using the product correlation degree. When the product correlation degree is calculated only using the social media correlation degree, the sales amount y(t) can be calculated using the social media correlation degree and the expression 4.

The product demand prediction unit 210 stores the sales amount calculated using the expression 4 (the demand prediction result) in the demand prediction data 211 and the external factor data 212.

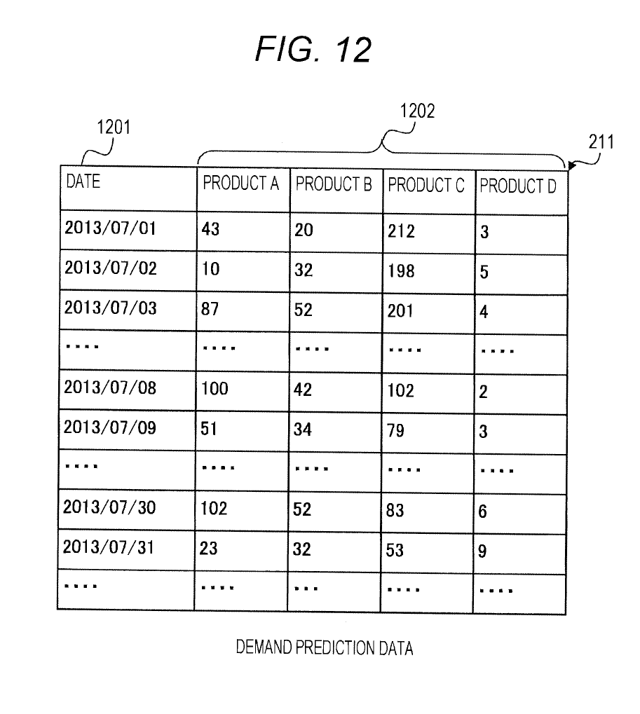

FIG. 12 is an explanatory diagram of exemplary demand prediction data 211 according to the present embodiment.

The demand prediction data 211 includes, for example, a date 1201 and a demand prediction result 1202.

The date 1201 indicates a date (corresponding to the date t). The demand prediction result 1202 indicates the sales amount y(t) of each product calculated using the expression 4.

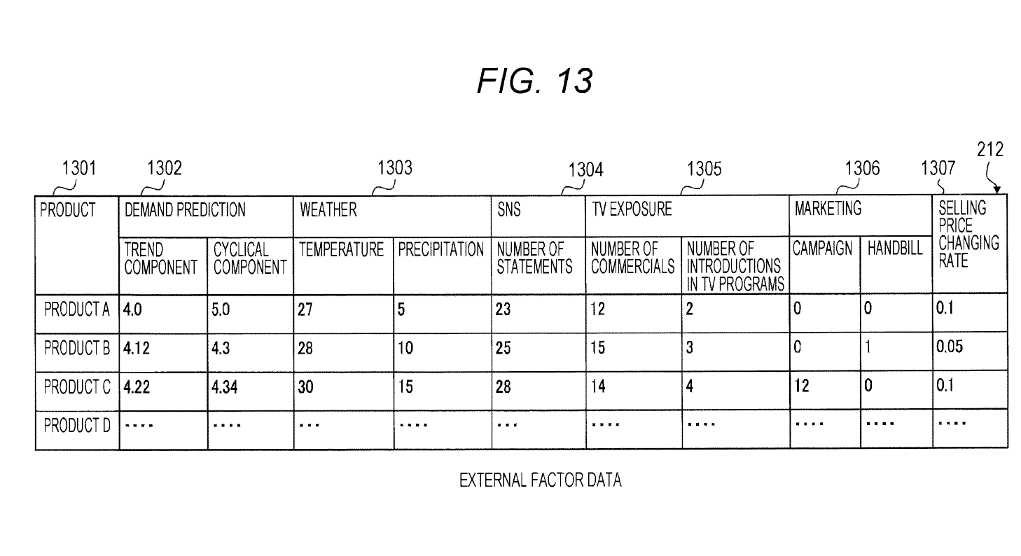

FIG. 13 is an explanatory diagram of exemplary external factor data 212 according to the present embodiment.

The external factor data 212 indicates the calculated regression coefficient aₘ of each of the explanatory variables in the expression 3. The external factor data 212 includes, for example, a product name 1301, a demand prediction influence degree 1302, a weather influence degree 1303, a social media influence degree 1304, a TV exposure influence degree 1305, a marketing influence degree 1306, and a selling price changing rate influence degree 1307.

The demand prediction influence degree 1302 stores the demand prediction coefficient B in the expression 3. The number of the types of the demand prediction coefficients varies depending on the applied demand prediction model. The demand prediction coefficient B illustrated in FIG. 13 includes the trend component and the cyclical component.

The weather influence degree 1303 indicates the calculated regression coefficient aₘ as the item in the weather data 1102 in the external event data 208. The social media influence degree 1304 indicates the calculated regression coefficient aₘ as the item in the statement frequency 402 in the social media intermediate data 204.

The TV exposure influence degree 1305 indicates the calculated regression coefficient aₘ as the item in the TV exposure data 1103 in the external event data 208. The marketing influence degree 1306 indicates the calculated regression coefficient aₘ as the item in the marketing data 1104 in the external event data 208. The selling price changing rate influence degree 1307 indicates the calculated regression coefficient aₘ as the item in the selling price changing rate 1105 in the external event data 208.

<Product Demand Prediction Screen>

The visualization unit 213 displays the demand prediction result to the user of the demand prediction device according to the present embodiment using the demand prediction data 211 and the external factor data 212. Furthermore, the visualization unit 213 receives an instruction about the prediction from the user to notify each function of the received instruction through the CPU 101.

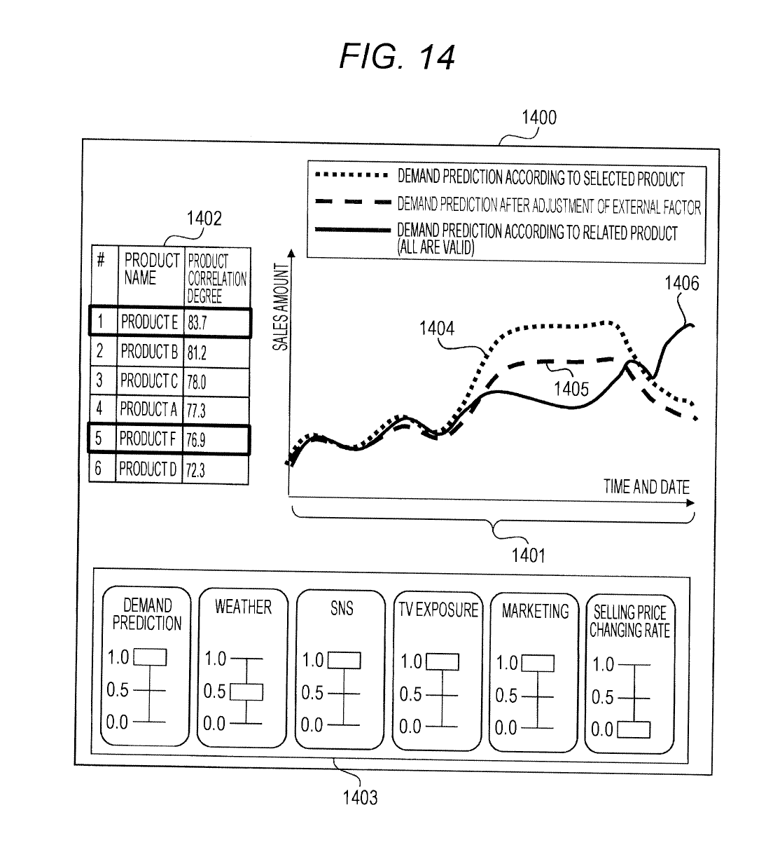

FIG. 14 is an explanatory diagram of an exemplary product demand prediction screen 1400 output from the visualization unit 213 according to the present embodiment.

The visualization unit 213 displays the product demand prediction screen 1400 on the output device 105. The product demand prediction screen 1400 includes at least the demand prediction graph 1401. The product demand prediction screen 1400 illustrated in FIG. 14 also includes a related product list 1402 and an external factor adjustment unit 1403.

The demand prediction graph 1401 shows the demand prediction data 211 about the product (the designated product) of which demand has been predicted using a graph. A solid line 1406 illustrated in FIG. 14 is the sales amount that the demand prediction data 211 indicates. A dotted line 1404 is the sales amount that has been calculated again when the user has selected the related product. A dashed line 1405 is the sales amount that has been calculated again when the user has selected the weight of the external factor.

The related product list 1402 displays a list of the related products used for predicting the demand for the designated product. Specifically, the related product list 1402 indicates the related product using the expression 4. As illustrated in FIG. 14, the related product list 1402 can display the product names of the related products and the product correlation degrees calculated in the expression 2. The order of display of the related products displayed in the related product list 1402 can be changed depending on the largeness of the product correlation degree.

The user can arbitrarily select a related product by operating the related product list 1402. The visualization unit 213 receives the related product selected by the user through the related product list 1402. The visualization unit 213 can highlight the selected related product, for example, by changing the color of the frame of the entry about the selected related product.

When the user has selected a related product from the related product list 1402, the visualization unit 213 gives the CPU 101 an instruction to calculate the sales amount y(t) again using the selected related product. When receiving the instruction about the related product from the visualization unit 213, the CPU 101 gives the product correlation degree calculation unit 205, the external factor contribution degree calculation unit 206, and the product demand prediction unit 210 an instruction to calculate the product correlation degree (for example, the social media correlation degree) again, calculate the external factor contribution degree again, and calculate the sales amount y(t) again using the selected related product.

After that, the visualization unit 213 obtains the output demand prediction data 211 and displays the dotted line 1404 using the obtained demand prediction data 211. The visualization unit 213 performs the processes every time the selected related product has been changed.

As illustrated in FIG. 14, the visualization unit 213 displays the demand prediction result from all the related products (the solid line 1406) and the demand prediction result from some of the related products (the dotted line 1404) in a demand prediction graph 1401. This enables the user to visually understand how the demand prediction varies depending on the selected related product.

The external factor adjustment unit 1403 displays the influence degree of the external factor contribution degree, which influences the sales amount of the related product, on the demand prediction to the user. The external factor adjustment unit 1403 displays all or some of the items of the external factors included in the external factor data 212 in FIG. 13 (the demand prediction influence degree 1302, the weather influence degree 1303, the social media influence degree 1304, the TV exposure influence degree 1305, the marketing influence degree 1306, and the selling price changing rate influence degree 1307). For example, the external factor adjustment unit 1403 can display a slide bar corresponding to each item as illustrated in FIG. 14 such that the user can arbitrarily adjust the influence degree using the slide bar.

For example, when the user wants to predict the demand for a product when the product is to be sold while the selling price changing rate is zero, the user operates the slide bar so as to change the influence degree of the selling price changing rate to zero illustrated as the external factor adjustment unit 1403 in FIG. 14. The visualization unit 213 receives the influence degree of the selling price changing rate changed by the user operation and inputs the changed influence degree of the selling price changing rate to the CPU 101. When the visualization unit 213 has input the changed influence degree of the selling price changing rate to the CPU 101, the CPU 101 inputs the changed influence degree of the selling price changing rate to the external factor contribution degree calculation unit 206.

The external factor contribution degree calculation unit 206 calculates the sales amount data based on the expression 3 and the input influence degree of the selling price changing rate and on the assumption that the regression coefficient of the explanatory variable term of the selling price changing rate is zero. After that, the product demand prediction unit 210 calculates the sales amount y(t) again using the sales amounts Y(t) of all the related products n that have been calculated again and the expression 4.

The visualization unit 213 draws the sales amount y(t) that has been calculated again as the demand prediction result in the demand prediction graph 1401. The dotted line 1404 illustrated in FIG. 14 shows the sales amount y(t) calculated after the external factor adjustment unit 1403 has changed the influence degree of the external factor. The visualization unit 213 illustrated in FIG. 14 displays the demand prediction result when all the external factor contribution degrees are valid (all the influence degrees have one) with the solid line 1406 while displaying the demand prediction result after some of the influence degrees of the external factor contribution degrees have been adjusted with the dotted line 1404. This enables the user to visually understand how the demand prediction result varies depending on the change of the influence of the external factor.

The user can also adjust the influence degree of the external factor contribution degree between zero and one using the external factor adjustment unit 1403. For example, when the user has changed the influence degree of the temperature illustrated in FIG. 14 to 0.5 and the external factor contribution degree calculation unit 206 calculates the sales amount data using the expression 3, the external factor contribution degree calculation unit 206 multiplies the regression coefficient of the explanatory variable term of the weather by 0.5 to calculate the sales amount data. This enables the user to appropriately reflect the input influence degree in the demand prediction result.

Then, the product demand prediction unit 210 calculates the demand prediction in the expression 4 again using a sales amount Y that is the result from calculating the sales amount data about all the related products again.

The external factor adjustment unit 1403 can display the slide bars such that a value equal to or larger than 1.0 can be set. Thus, the external factor adjustment unit 1403 enables the user to input the influence degree of each item of the external factors.

The demand prediction device and method according to the present embodiment have been described above.

The demand prediction device according to the present embodiment can predict the demand for (the sales amount of) a product that has not been released by calculating the correlation degree between the products using the social media data 201.

The demand prediction device according to the present embodiment can also predict the sales amount of a product based on the regional characteristics of the region in which the product is to be sold, the competitiveness between the product to be sold and another product, various external factors such as advertisements and the weather condition (corresponding to the external factor data 212) in addition to the consumer's reputation or feeling. Thus, the demand prediction device according to the present embodiment can predict the sales amount in consideration of not only the earnings of the consumers but also the factors that vary the prediction of the sales.

The above-mentioned demand prediction device predicts the sales amount of the product that is not dealt in. However, the demand prediction device can predict the demand for the product that has already been dealt in in a similar manner. A well-known demand prediction model is a method for predicting the demand for the product that has already been dealt in. However, when the demand is predicted using the demand prediction device according to the present embodiment, the prediction result can include the influence of the external data such as the reputation in the social media.

There is sometimes a difference between the demand prediction and the actual sales amount when the operation of the device and program according to the present embodiment has been started after the start of the actual release of the product. In light of the foregoing, for example, when the actual sales amount is lower than the demand prediction by a predetermined difference or larger, the visualization unit 213 can display the warning on the product demand prediction screen 1400 illustrated in FIG. 14. Note that the sales amount data 207 is updated, for example, by the day.

When a warning is displayed on the product demand prediction screen 1400, the user, for example, can determine the commercial policy for the product such that the increase in the selling price changing effect and the advertising effect increases the sales amount, and can obtain the demand prediction while increasing the influence degree of the selling price changing rate and the influence degree of the marketing data using the product demand prediction screen 1400.

When the number of statements on the product to be predicted in the social media has rapidly increased after the release in the social media intermediate data 204, the visualization unit 213 can display the recommendation for the action increasing the external factor contribution degree of the number of statements in the SNS.

In the present embodiment, the product information 209 can include the information about the product according to the business of the user of the demand prediction device according to the present embodiment. For example, when the user of the demand prediction device according to the present embodiment is a manufacturer, the product information 209 can be a list of the products that the user's company and the competitor deal in.

The demand prediction device, method, and program according to the present embodiment do not have to necessarily perform all the functions in a device as illustrated in FIGS. 1 and 2. The functions can be divided into a plurality of devices such that parallel processing or distributed processing can be performed as necessary.

The present invention is not limited to the embodiment, and includes various exemplary variations. For example, the embodiment is the detailed description of the present invention in an easily understood manner. The present invention is not necessarily limited to the embodiment including all the described components.

Some or all of the components, functions, processing units, processes, and the likes can be implemented with hardware, for example, designed as an integrated circuit. The information in the programs, tables, files for implementing each function can be stored in a recording device such as a memory, a hard disk, or a solid state drive (SSD), or a recording medium such as an IC card, a SD card, or a DVD.

The control lines and information lines necessary for the description are illustrated. All the control lines and information lines in the product are not necessarily illustrated. It would be considered that almost all the components are connected to each other in an actual product.

What is claimed is:

1. A calculating machine, comprising:
a processor; and
a memory,
wherein the calculating machine stores intermediate data generated for each of a plurality of products or services based on social media data including statements on the products or services for a predetermined period of time in the memory,
the intermediate data includes at least a frequency of statements on each of the products or services for the predetermined period of time,
the products or services include a first product or service that is not displayed for provision to a consumer at a present time, and at least a second product or service that has been displayed for provision at the present time, and
the calculating machine stores sales amount data indicating a sales amount of the second product or service in the memory, and includes a correlation degree calculation unit configured to calculate a social media correlation degree indicating a correlation between the intermediate data about the first product or service and the intermediate data about the second product or service, and a demand prediction unit configured to predict a sales amount of the first product or service based on the calculated social media correlation degree and the sales amount data about the second product or service.

2. The calculating machine according to claim 1,
wherein the calculating machine stores a release time indicating a time when release of each of the products or services is started or a time when release of each of the products or services has been started in the memory, and
the correlation degree calculation unit finds a relationship between a release time of the first product or service and the present time for the first product or service, finds a release time of the second product or service and a reference time having a relationship identical to the found relationship for the second product or service, and extracts the intermediate data about the second product or service before the found reference time in order to calculate the social media correlation degree from the extracted intermediate data about the second product or service and the intermediate data about the first product or service.

3. The calculating machine according to claim 1,
wherein the calculating machine stores product information indicating attribute of each of the products or services in the memory,
the correlation degree calculation unit calculates a distance indicating a difference between attribute of the first product or service and attribute of the second product or service based on the product information, and
the demand prediction unit predicts the sales amount of the first product or service based on the calculated social media correlation degree, the calculated distance, and the sales amount data of the second product or service.

4. The calculating machine according to claim 3, further comprising:
an input and output unit configured to receive an instruction from a user; and
a visualization unit configured to display an identifier of the second product or service and the predicted sales amount of the first product or service on the input and output unit,
wherein the visualization unit receives the identifier of the second product or service instructed by the user through the input and output unit, and
the correlation degree calculation unit calculates the social media correlation degree indicating a correlation between the intermediate data about the second product or service to which the identifier is instructed and the intermediate data about the first product or service.

5. The calculating machine according to claim 4,
wherein the calculating machine stores external factor data indicating a state by a predetermined period of time when each of the products or services has been provided,
the sales amount data indicates a sales amount of the second product or service by the predetermined period of time,
the calculating machine includes an external factor contribution degree calculation unit configured to analyze external factor data about the second product or service in a multiple regression analysis based on the external factor data about the second product or service and the sales amount data about the second product or service to calculate a regression coefficient of the external factor data about the second product or service in order to calculate a prediction sales amount using the calculated regression coefficient, and
the demand prediction unit predicts the sales amount of the first product or service based on the prediction sales amount calculated with the external factor contribution degree calculation unit, the social media correlation degree, and the calculated distance.

6. The calculating machine according to claim 5,
wherein the visualization unit displays an influence degree of the calculated regression coefficient and the predicted sales amount of the first product or service through the input and output device and receives the influence degree instructed by the user through the input and output device, and
the external factor contribution degree calculation unit calculates the prediction sales amount based on the instructed influence degree and the calculated regression coefficient.

7. The calculating machine according to claim 6, wherein the external factor contribution degree calculation unit updates the regression coefficient with a result obtained by multiplying the instructed influence degree by the calculated regression coefficient to calculate the prediction sales amount using the updated regression coefficient.

8. A prediction method using a calculating machine including a processor and a memory,
wherein the calculating machine stores intermediate data generated for each of a plurality of products or services based on social media data including statements on the products or services for a predetermined period of time in the memory,
the intermediate data includes at least a frequency of statements on each of the products or services for the predetermined period of time,
the products or services include a first product or service that is not displayed for provision to a consumer at a present time, and at least a second product or service that has been displayed for provision at the present time,
the calculating machine stores sales amount data indicating a sales amount of the second product or service in the memory,
the method comprising:
calculation of a correlation degree in which a social media correlation degree indicating a correlation between the intermediate data about the first product or service and the intermediate data about the second product or service is calculated by the processor; and
prediction of a demand in which a sales amount of the first product or service is predicted by the processor based on the calculated social media correlation degree and the sales amount data about the second product or service.

9. The prediction method according to claim 8,
wherein the calculating machine stores a release time indicating a time when release of each of the products or services is started or a time when release of each of the products or services has been started in the memory, and
the calculation of the correlation degree includes finding, by the processor, a relationship between a release time of the first product or service and the present time for the first product or service, finding, by the processor, a release time of the second product or service and a reference time having a relationship identical to the found relationship for the second product or service, extracting, by the processor, the intermediate data about the second product or service before the found reference time, and calculating, by the processor, the social media correlation degree from the extracted intermediate data about the second product or service and the intermediate data about the first product or service.

10. The prediction method according to claim 8,
wherein the calculating machine stores product information indicating attribute of each of the products or services in the memory,
the calculation of the correlation degree includes calculating, by the processor, a distance indicating a difference between attribute of the first product or service and attribute of the second product or service based on the product information, and
the prediction of the demand includes predicting, by the processor, the sales amount of the first product or service based on the calculated social media correlation degree, the calculated distance, and the sales amount data of the second product or service.

11. The prediction method according to claim 10,
wherein the calculating machine further includes an input and output unit configured to receive an instruction from a user,
the method includes visualization of displaying an identifier of the second product or service and the predicted sales amount of the first product or service on the input and output unit,
the visualization includes receiving, by the processor, the identifier of the second product or service instructed by the user through the input and output unit, and
the calculation of the correlation degree includes calculating, by the processor, the social media correlation degree indicating a correlation between the intermediate data about the second product or service to which the identifier is instructed and the intermediate data about the first product or service.

12. The prediction method according to claim 11,
wherein the calculating machine stores external factor data indicating a state by a predetermined period of time when each of the products or services has been provided,
the sales amount data indicates a sales amount of the second product or service by the predetermined period of time,
the method includes calculating an external factor contribution degree in which the processor analyzes external factor data about the second product or service in a multiple regression analysis based on the external factor data about the second product or service and the sales amount data about the second product or service to calculate a regression coefficient of the external factor data about the second product or service in order to calculate the prediction sales amount using the calculated regression coefficient, and
the prediction of the demand includes predicting, by the processor, the sales amount of the first product or service based on the prediction sales amount calculated in the calculation of the external factor contribution degree, the social media correlation degree, and the calculated distance.

13. The prediction method according to claim 12,
wherein the visualization includes displaying, by the processor, an influence degree of the calculated regression coefficient and the predicted sales amount of the first product or service through the input and output device and receiving, by the processor, the influence degree instructed by the user through the input and output device, and
the calculation of the external factor contribution degree includes calculating, by the processor, the prediction sales amount based on the instructed influence degree and the calculated regression coefficient.

14. The prediction method according to claim 13, wherein the calculation of the external factor contribution degree includes updating, by the processor, the regression coefficient with a result obtained by multiplying the instructed influence degree by the calculated regression coefficient, and calculating, by the processor, the prediction sales amount using the updated regression coefficient.

15. A prediction program for causing a calculating machine including a processor and a memory to perform processes,
wherein the calculating machine stores intermediate data generated for each of a plurality of products or services based on social media data including statements on the products or services for a predetermined period of time in the memory,
the intermediate data includes at least a frequency of statements on each of the products or services for the predetermined period of time,
the products or services include a first product or service that is not displayed for provision to a consumer at a present time, and at least a second product or service that has been displayed for provision at the present time,
the calculating machine stores sales amount data indicating a sales amount of the second product or service in the memory, and
the prediction program causing the calculating machine to perform the processes comprising:
calculation of a correlation degree in which a social media correlation degree indicating a correlation between the intermediate data about the first product or service and the intermediate data about the second product or service are calculated; and
prediction of a demand in which a sales amount of the first product or service is predicted based on the calculated social media correlation degree and the sales amount data about the second product or service.
